(19) United States
(12) Patent Application Publication
(10) Pub. No.: US 2021/0287226 A1
(43) Pub. Date: Sep. 16, 2021

(54) SYSTEM AND METHOD FOR MANAGING INTANGIBLE SHOPPING TRANSACTIONS IN PHYSICAL RETAIL STORES

(71) Applicant: MOTOROLA SOLUTIONS, INC., CHICAGO, IL (US)

(72) Inventors: MARIYA BONDAREVA, BOLINGBROOK, IL (US); ZILI LI, CHICAGO, IL (US); BRIAN J. FROMMELT, DEER PARK, IL (US)

(21) Appl. No.: 16/817,254

(22) Filed: Mar. 12, 2020

(51) Int. Cl. G06Q 30/00; G06Q 30/02; G06K 7/14; G08B 21/24; G06K 9/00

(52) U.S. Cl. CPC G06Q 30/016; G06Q 30/0281; G06K 9/00362; G08B 21/24; G06K 9/00288; G06K 7/1417

(57) ABSTRACT

A method for managing intangible shopping transactions in a physical retail store is provided. The method may include monitoring a customer shopping within a physical retail store to detect occurrence of an intangible transaction. The method may also include determining that the intangible transaction has occurred. The method may further include storing a record of a transaction item associated with the intangible transaction, the record associated with the customer. The method may additionally include determining the customer is attempting to leave the physical retail store while not in possession of the transaction item. The method may also include providing an alert to indicate the customer is attempting to leave the physical retail store while not in possession of the transaction item.

### BACKGROUND

In an attempt to increase customer satisfaction as well as reduce operating expenses, many physical retail stores have introduced customer self-service checkout kiosks. A customer may interact with the kiosk by scanning the universal product code (UPC) of the items he wishes to purchase. The kiosk may keep a running total of the amount the customer owes, adds any sales taxes due, etc. Once the customer has completed scanning his items, the kiosk may provide the ability for the customer to pay for the items purchased. In the majority of cases, the kiosk will accept credit and debit cards for payment. In some cases, cash and other forms of payment may be accepted as well. Such systems are beneficial to both the customer and the retailer because many kiosks may be installed (reducing customer checkout wait time) while at the same time reducing, and possibly eliminating, the number of people needed to operate checkout counters (reducing the retailer's labor costs).

Some retail establishments have gone a step further and have effectively eliminated the checkout process completely. For example, the Amazon Go stores utilize computer vision, weight sensors on shelves, and deep learning to remove the need for a checkout process at all. When a customer arrives at the physical store, they simply scan a QR code produced by an app on their smartphone. The customer then simply shops as normal. Through the use of computer vision and weight sensors the store detects the objects that were picked up (or even placed back down) by the customer, and records those items in a virtual shopping cart. Once the customer has finished shopping, he simply leaves the store with no checkout process required. The customer's account is then charged for all items that were present in their virtual shopping cart at the time they left the store.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments

FIG. 1 is a diagram of an example physical retail store that may implement the intangible shopping transactions in a physical retail store techniques described herein.

FIGS. 2A and 2B are an example of a flow diagram for implementing intangible shopping transactions in a physical retail store techniques described herein.

FIG. 3 is an example of a device that may implement the intangible shopping transactions in a physical retail store techniques described herein.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

The techniques to increase customer satisfaction while reducing retailer operating expenses described thus far all have one thing in common; the customer physically interacts with the products being purchased. In the case of the self-service checkout kiosk, the customer physically scans the product being purchased. In the case of the Amazon Go type store, the store keeps track of items the customer has physically picked up. In the case of a traditional customer checkout experience, a customer presents items to be purchased to a cashier, who then proceeds with the checkout process.

There is another type of transaction, hereinafter referred to as an intangible transaction, in which a customer may express an intent to purchase an item, but does not immediately physically interact with the item. Several examples of intangible transactions are provided below. Because intangible transactions do not involve the customer physically interacting with the product, the techniques described above are not capable of handling some issues related to intangible transactions.

One example of an intangible transaction may occur at a pharmacy (e.g. a pharmacy located within a grocery store, big box store, etc.). A customer may approach the pharmacy counter to request that a prescription be filled. In some cases, the customer may hand the pharmacist a physical paper prescription slip. In most cases, the customer's doctor may have simply sent an electronic prescription to the pharmacy, and there is no physical interaction between the customer and the pharmacist at all. Filling the prescription may involve more than just handing the medication to the customer. The pharmacist may need to verify the prescription with the doctor, check for drug interactions with other medications the customer is taking, and other such tasks that require time to complete. The pharmacist may instruct the customer to return after some period of time to pick up the filled prescription. The customer may then proceed to conduct other shopping within the store while waiting for the prescription to be filled. It should be noted that until the customer returns to pick up the prescription, he has not yet physically interacted with the item (e.g. the medication, etc.) that is being purchased.

Another example of an intangible transaction may occur with orders for items that may require processing by the retailer before being given to the customer are placed. For example, consider a butcher counter at a grocery store. A customer may interact with the butcher to select an item to be purchased (e.g. points to a particular cut of meat in a display case). The customer may then request that his selection be processed (e.g. remove the skin from a fish, cook a steak to medium rare, etc.). The butcher may then tell the customer to return after a period of time to retrieve the processed item. Again, it should be noted that until the customer returns to retrieve the item, there is no physical interaction with the item being purchased. Although a butcher counter has been described, it should be understood that this is only an example. Other examples may include a deli counter (e.g. requesting a certain weight of sliced meat, etc.), a florist (e.g. requesting a custom flower arrangement, etc.), a bakery (e.g. requesting custom message on a cake, etc.). What should be understood is that the retailer is processing the item that is being purchased in some way and that processing may require time to complete.

Yet another type of intangible transaction may occur when a customer engages in an order online/pickup in store transaction. Until the customer arrives at the store and retrieves the ordered item, there is no physical interaction between the customer and the ordered item.

A problem may arise when a customer forgets to pick up the item associated with an intangible transaction. For example, in the case of a pharmacy, the customer may forget to pick up his prescription before leaving the store. This may result in great inconvenience to the customer, as he may need to return to the store to pick up his forgotten prescription. If the customer does not return to pick up his prescription, the retailer suffers the expense required for returning the prescription to stock as well as the expense incurred in preparing the prescription in the first place. A similar situation arises when a customer orders an item online for in-store pick up, arrives at the store and purchases other items, but forgets to pick up the item that was ordered online. The customer is either inconvenienced by having to return to the store to retrieve the item or the retailer must expend effort (thus incurring a cost) in refunding the customer for their online purchase and then returning the purchased item to stock.

The problem may be even worse in the case where the item being purchased has been processed based on the customer request. In such cases, it may not be possible to return the item to stock at all (e.g. a steak that has been cooked cannot be returned to the display counter, a cake that has a customized message will likely be difficult to resell, sliced deli meat may no longer be sellable, etc.). If the customer does not return to pick up the item that was the subject of the intangible transaction, the retailer may be forced to discard the item, thus taking a full loss on the cost of the item as well as the cost incurred for processing the item.

The techniques described herein overcome these problems, individually and collectively. Locations of a retail store where intangible transactions are likely to occur may be monitored using audio and video analytics. Systems that are utilized when conducting intangible transactions (e.g. order taking systems) may also be monitored. When a customer engages in an intangible transaction, a record reflecting the transaction may be produced and associated with the customer conducting the transaction.

When the customer is preparing to leave the store, the system may determine if the customer has engaged in any intangible transactions. It may be determined if the items associated with the intangible transaction are currently in the customer's possession. For example, in a case of a self-service kiosk it may be determined if the customer has scanned the item associated with the intangible transaction. This same technique could also be used with an employee operated checkout counter. In cases where the store monitors customer interaction with products (e.g. Amazon Go, etc.), the system can determine if the customer has returned to pick up the item associated with the intangible transaction (e.g. is the item in the customer's virtual cart). In some implementations, video systems located near the store exits may be used to determine if the customer is in possession of the item.

If it appears that the customer is attempting to leave the store without the item associated with the intangible transaction, the customer and/or store personnel can be informed. The customer is able to avoid the inconvenience of having to make a return trip to the store and the retailer is able to avoid the loss associated with intangible transaction items that are not picked up but cannot be returned to stock.

It should be further noted that in some of the scenarios described above, there is no need to personally identify the customer that engaged in the intangible transaction. For example, facial recognition could be used to identify a face associated with an intangible transaction. There is no need to attach an identity to the face. The system could simply record that a given face engaged in an intangible transaction (e.g. “Face A” dropped off a prescription) and that same face is attempting to leave the store while not in possession of the item associated with the intangible transaction (e.g. “Face A” is leaving store without his prescription). There is no need to ever personally identify (e.g. by name, address, etc.) the actual human being associated with “Face A.”

Furthermore, there is no need to retain any of the information associated with the customer. As soon as the customer leaves the store, any information used to associate the intangible transaction to a customer can be deleted. Continuing with the above example, even though “Face A” is not associated with personally identifiable information, there is no need to store any record at all of the existence of the customer with “Face A” having been in the store at all, once he has left.

The scenario associated with a customer placing an online order for pick up in store may give the customer the option to opt-in to providing identification information associated with the online order. Because the online order itself is personally identifying (e.g. contains the customer's name, address, billing information, etc.) the identification information may become personally identifying. For example, the customer may place an online order for in-store pickup and include an image of his face. Facial recognition systems at the store may compare the facial image to the faces of everyone entering the store. When the customer arrives at the store his face may be matched with the online order. The customer may then be monitored, just as above, to ensure that he does not leave the store without the item associated with the intangible transaction. Just as above, once the customer has left the store with the item associated with the intangible transaction, all identifying information associated with the customer, whether personally identifying or not, may be purged.

A method is provided. The method includes monitoring a customer shopping within a physical retail store to detect occurrence of an intangible transaction. The method also includes determining that the intangible transaction has occurred. The method further includes storing a record of a transaction item associated with the intangible transaction, the record associated with the customer. The method also includes determining the customer is attempting to leave the physical retail store while not in possession of the transaction item. The method also includes providing an alert to indicate the customer is attempting to leave the physical retail store while not in possession of the transaction item.

In one aspect, the monitoring of the customer occurs only in locations within the physical retail store where intangible transactions are likely to occur. In one aspect the alert is provided to at least one of: the customer; and an employee of the physical retail store. In one aspect, the monitoring further comprises: identifying the customer by at least one of: facial recognition; body recognition; and clothing recognition. In one aspect, identifying the customer does not include personally identifying information, and further comprises: deleting data associated with identifying the customer when the customer leaves the physical retail store.

In one aspect, detecting that an intangible transaction has occurred comprises at least one of: monitoring audio communication between the customer and an employee of the physical retail store; monitoring, via video, physical interaction between the customer and the employee of the physical retail store; and monitoring records created by the employee of the physical retail store. In one aspect, the intangible transaction occurred prior to the customer entering the physical retail store, wherein monitoring the customer further comprises: receiving an opt-in indication from the customer to be personally identified; and detecting that the personally identified customer has entered the physical retail store.

A system is provided. The system includes a processor and a memory coupled to the processor, the memory containing a set of instructions thereon that when executed by the processor cause the processor to monitor a customer shopping within a physical retail store to detect occurrence of an intangible transaction. The instructions further cause the processor to determine that the intangible transaction has occurred. The instructions further cause the processor to store a record of a transaction item associated with the intangible transaction, the record associated with the customer. The instructions further cause the processor to determine the customer is attempting to leave the physical retail store while not in possession of the transaction item. The instructions further cause the processor to provide an alert to indicate the customer is attempting to leave the physical retail store while not in possession of the transaction item.

In one aspect, the instructions to provide an alert further comprises instructions to provide the alert to at least one of: the customer; and an employee of the physical retail store. In one aspect, the instructions to monitor the customer further comprises instructions to identify the customer by at least one of: facial recognition; body recognition; and clothing recognition. In one aspect, the instructions to identify the customer does not include personally identifying the customer, further comprising instructions to: delete data associated with identifying the customer when the customer leaves the physical retail store.

In one aspect, the instructions to detect that an intangible transaction has occurred comprises instructions to at least one of: monitor audio communication between the customer and an employee of the physical retail store; monitor, via video, physical interaction between the customer and the employee of the physical retail store; and monitor records created by the employee of the physical retail store. In one aspect, the intangible transaction occurred prior to the customer entering the physical retail store, wherein the instructions to monitor the customer further comprises instructions to: receive an opt-in indication from the customer to be personally identified; and detect that the personally identified customer has entered the physical retail store.

A non-transitory processor readable medium containing a set of instructions thereon is provided. The instructions, when executed by a processor, cause the processor to: monitor a customer shopping within a physical retail store to detect occurrence of an intangible transaction. The instructions further cause the processor to determine that the intangible transaction has occurred. The instructions further cause the processor to store a record of a transaction item associated with the intangible transaction, the record associated with the customer. The instructions further cause the processor to determine the customer is attempting to leave the physical retail store while not in possession of the transaction item. The instructions further cause the processor to provide an alert to indicate the customer is attempting to leave the physical retail store while not in possession of the transaction item.

In one aspect, the instructions to provide an alert further comprises instructions to provide the alert to at least one of: the customer; and an employee of the physical retail store. In one aspect, the instructions to monitor the customer further comprises instructions to identify the customer by at least one of: facial recognition; body recognition; and clothing recognition. In one aspect, the instructions to identify the customer does not include personally identifying the customer, further comprising instructions to: delete data associated with identifying the customer when the customer leaves the physical retail store.

In one aspect, the instructions to detect that an intangible transaction has occurred comprises instructions to at least one of: monitor audio communication between the customer and an employee of the physical retail store; monitor, via video, physical interaction between the customer and the employee of the physical retail store; and monitor records created by the employee of the physical retail store. In one aspect, the intangible transaction occurred prior to the customer entering the physical retail store, wherein the instructions to monitor the customer further comprises instructions to: receive an opt-in indication from the customer to be personally identified; and detect that the personally identified customer has entered the physical retail store.

Further advantages and features consistent with this disclosure will be set forth in the following detailed description, with reference to the figures.

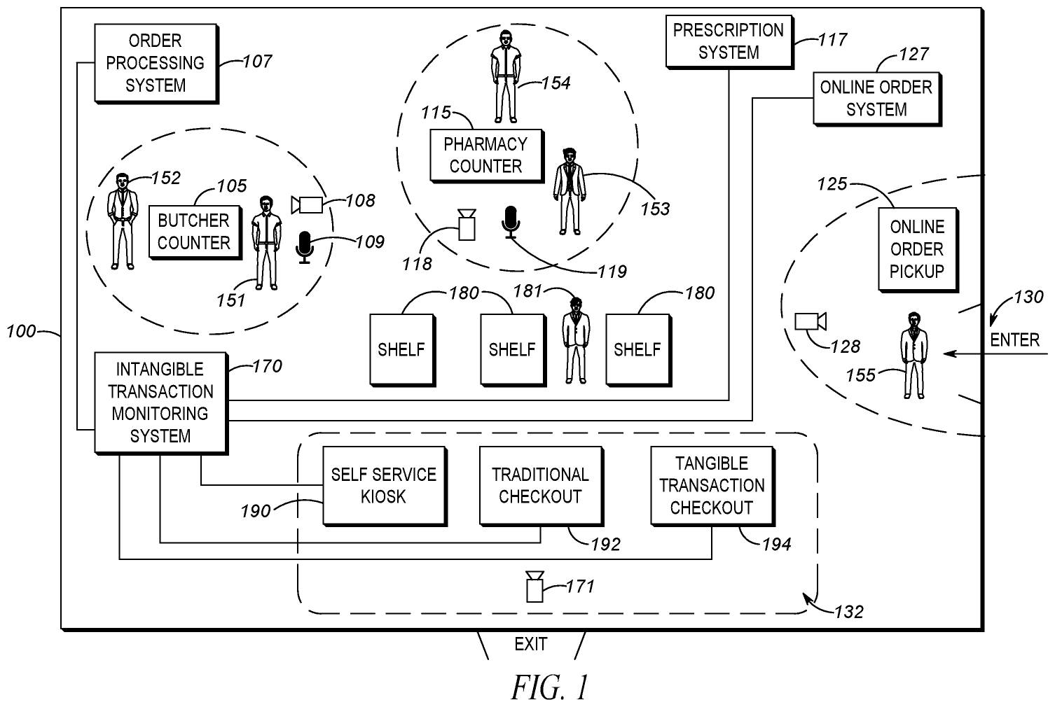

FIG. 1 is a diagram of an example physical retail store that may implement the intangible shopping transactions in a physical retail store techniques described herein. Although a particular layout of physical retail store 100 is described, it should be understood that this is merely an example. The techniques described herein may be utilized in any location where intangible transactions may occur.

Physical retail store 100 may include several areas where intangible transactions are expected to occur. For example, a butcher counter 105 may be a location in a grocery store where meat products are displayed. A customer 151 may interact with an employee of the physical retail store who is assigned to the butcher counter (e.g. butcher counter attendant 152) to place an order for a meat product. Such an order may include selection of piece of meat, instructions for processing the meat (e.g. remove skin, cook to desired level of doneness, etc.). In some implementations, the butcher counter attendant 152 may log the order in an order processing system 107. For example, order processing system 107 may be a computer where orders are logged.

The order processing system 107 may manage the butcher counter 105 workflow. For example, a customer may place an order for a fish, and request that the skin be removed from the fish. The butcher counter attendant 152 may log the order in the order processing system 107 and instruct the customer 151 to return after some period of time to retrieve the fish. A butcher counter employee (not shown) may access the order processing system 107 to fill the order (e.g. remove the skin from the fish and wrap it up to be given to the customer 151).

In some implementations, the butcher counter 105 may include video 108 and/or audio 109 monitoring. The video 108 and audio 109 systems may be coupled to an intangible transaction monitoring system 170 and may be used to monitor intangible transactions occurring at the butcher counter 105. For example, the video monitoring system 108 may be used to identify a customer 151 that is engaging in an intangible transaction. For example, the video system 108 may utilize facial recognition to identify the customer 151. As mentioned above, the facial recognition need not personally identify the customer 151, but rather may simply be at a level that allows the store to match an image of a face with another image of a face, without needing to know who the face belongs to. In other implementations, the video system 108 may utilize the clothing (e.g. appearance, etc.) of the customer 151 to identify the customer. The techniques described herein are not limited to any particular type of video identification of the customer 151. Any technique that allows the customer 151 to be identified would be suitable for use with the techniques described herein.

In some implementations, the butcher counter area may be monitored by an audio system 109. The audio system 109 may utilize a microphone to record the speech of the customer 151. Audio analytics may then be used to detect when the customer has placed an order (e.g. “I would like that fish. Please remove the skin.”). There are many known audio analytic techniques that may be used to determine a customer's intent to purchase a product. The techniques described herein may utilize any available audio analytic technique to determine that the customer 151 has engaged in an intangible transaction with the butcher counter attendant 152.

A setup similar to the butcher counter 105 may also exist at the pharmacy counter 115. A pharmacy customer 153 may engage in an intangible transaction with a store employee 154 who is assigned to the pharmacy counter (e.g. pharmacist, pharmacy tech, etc.). The pharmacy customer 153 may request that a prescription be filled. Given the regulated nature of pharmacy transactions, the store employee 154 will likely enter the order into a prescription system 117. As above, the prescription system 117 may control the workflow of filling prescriptions within the pharmacy. Also, as above, the pharmacy counter may have a video 118 and/or audio 119 system to identify customers as well as determine if the customer has engaged in an intangible transaction. Although the pharmacy counter 115 may include an audio system 119, it should be understood that the detection of an intangible transaction will most likely occur through the prescription system 117.

The store 100 may also include an online order pick up counter 125. A customer 155 may have placed an order online prior to arriving at the store by utilizing an online order system 127. The online order system 127 may control the workflow for online orders. For example, as an order is received, store employees may be assigned to go the various areas of the store to gather the items that have been ordered. Those items may then be waiting for the customer 155 when he arrives at the store.

There may be a video system 128 that is associated with the online ordering system 127. However, unlike the butcher counter 105 and pharmacy 115, the video monitoring system 128 associated with the online order pickup counter 125 may be directed not only to the pickup counter but also to an entrance 130 of the store to monitor customers as they enter. As explained briefly above, a customer 155 that engages in an online order may opt-in to providing an image of their face. The video system 128 may then monitor faces of customers entering the store to determine when a customer who has placed an online order has entered the store. It should be noted that there is no need for an audio system to be associated with the online order pickup counter 125, as the customer 155 will have already placed their order online (e.g. engaged in the intangible transaction), prior to even entering the store 100.

It should also be noted that physical retail store 100 may have areas in which it is not expected for intangible transactions to occur. For example, as shown, the middle of the store may include a plurality of shelves 180 from which a customer 181 may select items (e.g. engage in a tangible transaction). Because it is not expected for intangible transactions to occur in these areas of the store 100, there is no need to conduct video and/or audio monitoring in those areas. As such, the amount of monitoring of customers can be reduced. Although shelves are described, it should be understood that the particular layout of the store 100 is not important. What should be understood is that monitoring video and/or audio of customers need only occur in locations of the store where intangible transactions are expected to occur.

Physical store 100 may include a plurality of checkout stations of different types. For example, self-service kiosk 190 may be a checkout station where the customer scans the items he wishes to purchase and presents payment, all without requiring interaction with a store employee. The store 100 may include traditional checkout 192 where an employee of the store may assist the customer with the checkout process. The store 100 may also include tangible transaction checkout 194, which is effectively a virtual checkout station. As mentioned above with the Amazon Go system, the store may keep track of items the customer interacted with by maintaining a record of those items in a virtual shopping cart. When the customer leaves the store, he may simply be charged for all items currently in his virtual shopping cart.

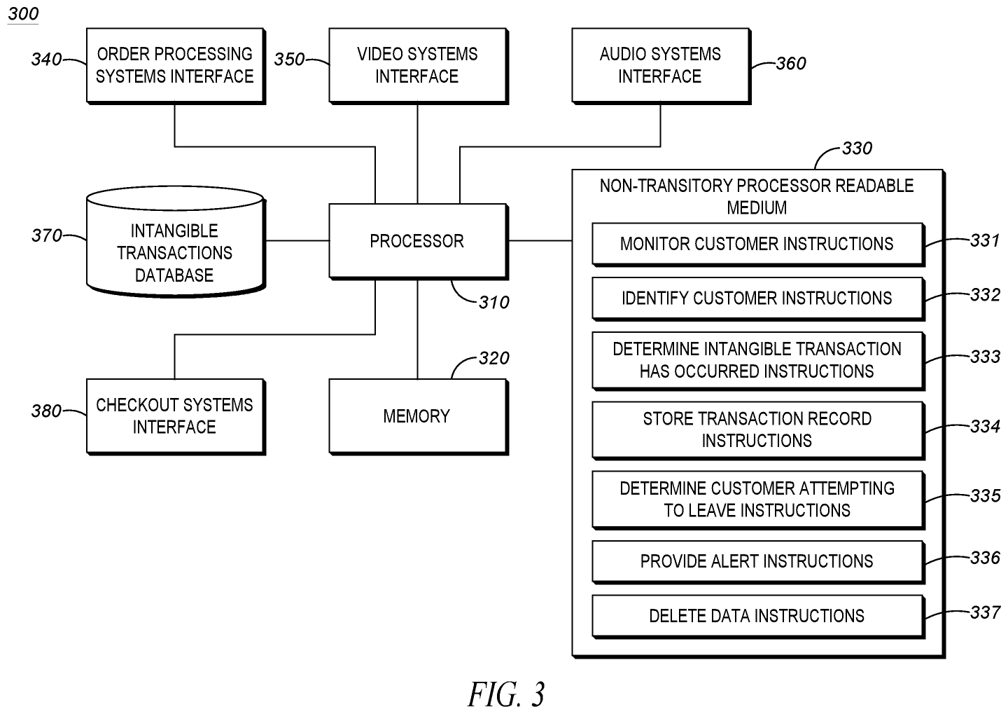

Physical store 100 may also include an intangible transaction monitoring system 170. An example of a hardware device that may implement intangible transaction monitoring system 170 is described with respect to FIG. 3. The intangible transaction monitoring system 170 may be coupled to order processing system 107, prescription system 117, and online order system 127. As such, the intangible transaction monitoring system 170 may be able to keep a record of all intangible transactions that occur within store 100 through the various ordering systems.

The intangible transaction monitoring system 170 may be associated with video system 171 which may be used to identify customers that are beginning the checkout process and/or leaving the store. The intangible transaction monitoring system 170 may be coupled to all video monitoring devices 108, 118, 128 in order to identify customers so that they may later be correlated with intangible transactions. The intangible transaction monitoring system 170 may be coupled to all audio monitoring devices 109, 119 in order to use audio analytics to determine that a customer has engaged in an intangible transaction. The intangible transaction monitoring system 170 may be coupled to all checkout stations 190, 192, and 194 in order for the system 170 to be notified when an identified customer is attempting to check out and leave the store.

Operation of store 100 will now be described through presentation of several use cases. In one use case, a customer 151 may have decided to engage in an intangible transaction at the butcher counter 105. For example, the customer 151 may wish to select a steak and have the steak cooked. The customer 151 may provide his selection and preparation instructions to the butcher counter attendant 152 by simply speaking his order. Audio system 109 may capture the audio of the order and send it to the intangible transaction monitoring system wherein through the use of audio analytics, it may be determined that the customer 151 has engaged in an intangible transaction. The butcher counter attendant 152 may tell the customer 151 to return after a period of time to collect his order.

The intangible transaction monitoring system 170 may use the video system 108 to identify the customer 151. For example, the video system 108 may use facial recognition technology, clothing recognition technology, appearance recognition technology, or any other technology that may be used to identify a person. The intangible transaction monitoring system may then assign an identifier to the customer 151 (e.g. “ABC123”). It should be understood that this identifier need not personally identify the customer 151 and may simply be used as a temporary identifier to track the customer while he is within the store. The intangible transaction monitoring system may then create a record in a database which includes the customer identifier as well as the object of the intangible transaction (e.g. the steak that is being cooked).

When the customer 151 approaches the checkout area his image may be captured by the video monitoring system 171. The intangible transaction monitoring system 170 may determine if there is any record associated with the customer 151. In this case, the intangible transaction monitoring system 170 may determine that it has previously identified the customer 151, and assigned him the identifier “ABC123” and that there exists a record in the database associating the customer identifier “ABC123” with the intangible transaction of ordering a cooked steak.

The intangible transaction monitoring system 170 may determine if the customer 151 is in possession of the object that is associated with the intangible transaction (e.g. the steak). For example, if the customer is using self-service kiosk 190 or traditional checkout 192, the intangible transaction monitoring system 170 may determine if the object associated with the intangible transaction has been scanned. If the customer completes checking out without having scanned the item associated with the intangible transaction, this may indicate he has forgotten to pick up the ordered item. In the case of using tangible transaction checkout 194, it may simply be determined if the item is in the customer's virtual cart, as it would have been added when the customer returned to the butcher counter 105 and picked up the item (e.g. physically interacted with the item).

If the customer attempts to complete the checkout process without the item associated with the intangible transaction, in some implementations the customer may be notified that they have forgotten an item. The notification can be in the form of a display screen on the checkout kiosk, a notification in an app associated with the virtual cart, a light or siren placed by the store exit 132, a notification to a store employee to interact with the customer to notify him that he has forgotten an item, or any other mechanism to notify the customer that he has forgotten the item associated with the intangible transaction.

The pharmacy counter 115 use case is very similar to the butcher counter use case. A customer 153 may approach the pharmacy counter 115 to request that a prescription be filled by a pharmacy employee 154. Although audio system 119 may be used to detect the intangible transaction, given the highly regulated/privacy focused nature of pharmacies, it is more likely that a prescription system 117 would be used to manage pharmacy prescription requests. Pharmacy employee 154 may enter the prescription request into prescription system 117. Just as above, video system 118 may be used to identify the customer 153 and assign a temporary identifier.

The intangible transaction monitoring system 170 may then create a record associating the assigned customer identifier with the transaction that was entered into the prescription system 117. Just as above, if the customer attempts to complete check-out while not in possession of the item associated with the intangible transaction, the customer 153 can be alerted that he has forgotten his prescription.

Yet another example use case may be when a customer 155 engages in an order online/pick up in store transaction. As part of that transaction, the customer may agree to provide an image of his face (or other identifiable image). Because the image is associated with an online transaction, which may include customer's name, address, credit card number etc., the image is likely to be considered personally identifiable information. However, it should be understood that the customer needs to opt-in to this process and may not be required to do so.

Upon placement of an online order using online ordering system 127, the intangible transaction monitoring system 170 may create a record that associates the customer provided image with the online transaction.

Upon arrival at the store 100, video system 128 may be used to identify that the customer 155 has arrived at the store by comparing video information received from video system 128 with the image provided by customer 155. The intangible transaction monitoring system 170 may then identify the item that the customer ordered online. A slight difference between the previous use cases is that the customer may not go through the checkout process. For example, if the customer 155 has ordered and paid online, he simply needs to collect his item from the online order pickup 125 location and leave the store 100.

Video system 128 may further monitor the online order pickup area 125 to identify that the customer 155 has retrieved the item that he ordered online. As explained above with respect to the Amazon Go system, once the customer 155 has picked up his item, he has physically interacted with it and the record can be updated to indicate that the item has actually been physically interacted with and is now in possession of the customer 155. In an alternate/additive implementation, video system 171 may monitor customer 155 as he is leaving the store to detect if he is holding the item associated with online order.

In some implementations, once the customer has left the store, there is no longer a need to maintain information related to the customer. All data used to identify the customer (e.g. facial recognition, clothing recognition, etc.), the temporary customer identifier, the records associated with the transactions, etc. can be purged. Thus, even though the data stored may not necessarily be able to personally identify a customer, the information can still be purged, helping to alleviate any concerns over storage of information that could be misused to track a person.

In other implementations, it may be desirable to keep track of a customer who engages in an intangible transaction, but then refuses to retrieve the item associated with the intangible transaction. For example, if a customer has a history of engaging in intangible transactions but then not picking up and paying for the item, the customer can be flagged as such. If the customer attempts to engage in an intangible transaction, an employee may be notified in order to take corrective action. For example, the customer may be told he needs to pay for the item associated with the intangible transaction prior to the order being processed. By doing so, the physical retail store does not incur a loss if the customer does not pick up the item, as it has already been paid for.

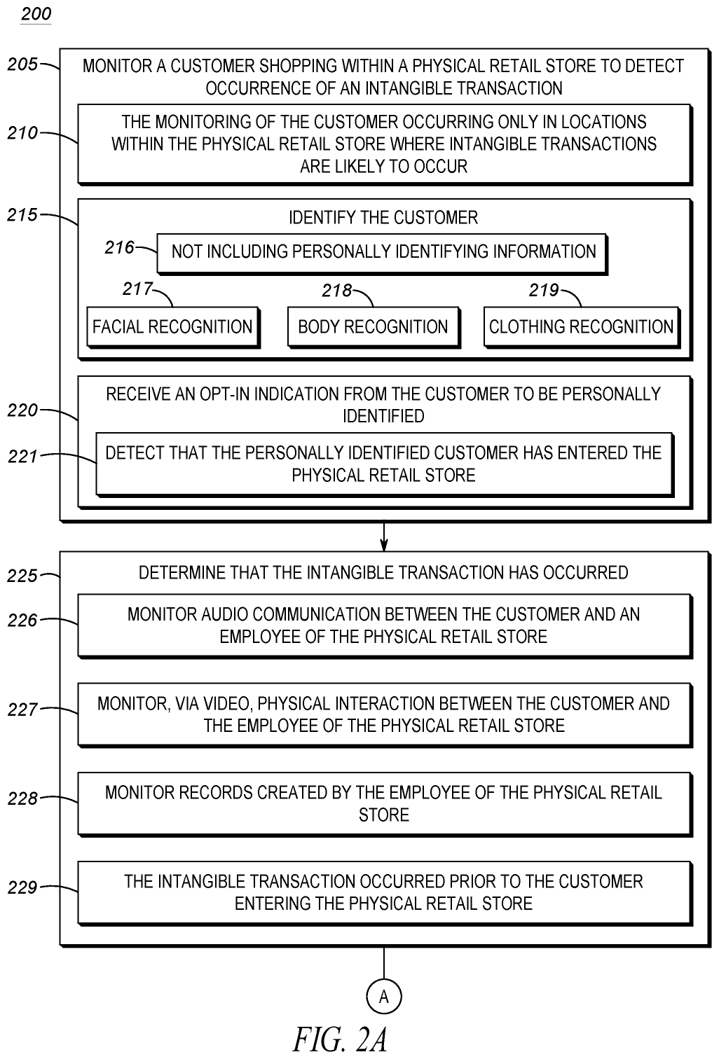

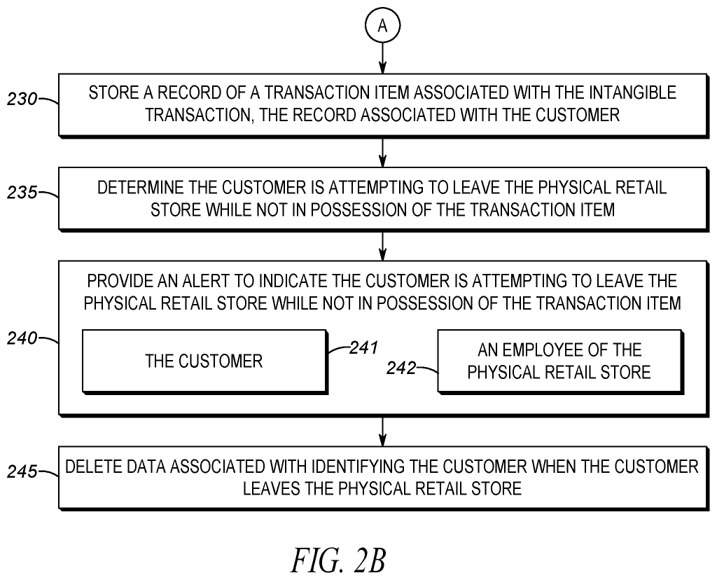

FIGS. 2A and 2B are an example of a flow diagram 200 for implementing intangible shopping transactions in a physical retail store techniques described herein. In block 205, a customer shopping within a physical retail store may be monitored to detect occurrence of an intangible transaction. As explained above, video and audio systems, as well as order transaction systems (e.g. order processing system 107, prescription system 117, online order system 127, etc.) may be utilized to detect the occurrence of an intangible transaction.

As shown in block 210, the monitoring of the customer may only occur in locations within the physical retail store where intangible transactions are likely to occur. In other words, there is no need, or even desire, to monitor customers throughout the entirety of the store. By only monitoring areas where intangible transactions are likely to occur, the amount of monitoring can be reduced. Not only does this reduce the amount of processing power utilized in monitoring all customers everywhere within the store, it also helps improve customer privacy, as they are not monitored other than in locations where intangible transactions may occur.

In block 215, the customer may be identified. As explained in block 216, in some cases, identifying the customer does not include personally identifying information. In other words, the customer can be identified for later comparison to that same customer (e.g. this person was seen at the butcher counter and the same person is seen at the checkout station). There is no need for the person to be identified with personally identifiable information (e.g. name, address, etc.).

Some examples of identifying information can include facial recognition, as shown in block 217. Again, the facial recognition may be to simply detect faces that match. There is no need to associate personally identifiable information with the identification. Another example recognition technique may be body recognition, as shown in block 218. In body recognition, aspects of a person's body (e.g. height, weight, length of arms, legs, etc.) may be used to identify and track a person. Yet another mechanism to identify a customer may include clothing recognition as shown in block 219. Clothing recognition may be used to identify and track a customer based on what they are wearing. It should be understood that the customer identification techniques described are simply examples. Any technology that may be utilized to identify that a person who was at one location within a store and is now at a checkout location are suitable for use with the techniques described herein.

In block 220, an indication to opt-in to being personally identified may be received from the customer. As explained above, in implementations involving online ordering/pick up in store transactions, it may be necessary for the customer to provide identification information, that in conjunction with the order details, may allow the customer to be personally identified. However, the customer may be required to opt-in to such functionality if so desired. In block 221, it may be detected that the personally identified customer has entered the physical retail store.

In block 225 it may be determined that the intangible transaction has occurred. As explained above, there are several different ways that detection of an intangible transaction may be achieved. One of those ways is shown in block 226, in which audio communication between the customer and an employee of the physical retail store may be monitored. For example, an audio monitoring system, such as a microphone, may capture audio of the customer and store employee interaction. Any known audio analytic may be used to determine that an intangible transaction has occurred.

Another example technique is shown in block 227, in which physical interaction between the customer and the employee of the physical retail store may be monitored via video. For example, in the case of a pharmacy counter, the physical interaction of a customer handing a paper prescription to a pharmacy technician may be monitored via video. In yet another example, as shown in block 228, records created by the employee of the physical store may be monitored. As described above, there may be order processing systems 107, 117 that may be used by store employees to record instances of intangible transactions. When a store employee enters such a record, that may be used to determine that an intangible transaction has occurred.

Block 229 describes an example of the intangible transaction having occurred prior to the customer entering the retail store. An example of such a transaction is an order online/pickup in store transaction. Online orders are by definition intangible transactions, as there is no ability for the customer to physically interact with the items being purchased.

In block 230 a record of a transaction item associated with the intangible transaction may be stored, the record being associated with the customer. In other words, when a customer engages in an intangible transaction, the item being ordered (e.g. the prescription, the piece of meat, etc.) is stored in a record that is associated with the identified customer. It is through this association that the system knows which items should be in the customer's possession when he leaves the store.

In block 235 it may be determined that the customer is attempting to leave the physical retail store while not in possession of the transaction item. It should be understood that leaving the store may also include beginning the checkout process. As explained above, this determination may be made in several ways. For example, the system may interact with the checkout process to determine if the transaction item has been scanned during the checkout process. As another example, it may be determined if the transaction item has been placed in the customer's virtual cart (e.g. he returned to pick up the transaction item, thus physically interacted with it). As yet another example, a video monitoring system, such as video monitoring system 171 may be used to determine if the customer is physically holding the transaction item as they are leaving the physical retail store.

In block 240, an alert may be provided to indicate that the customer is attempting to leave the physical retail store while not in possession of the transaction item. As shown in block 241, in some implementations the alert is provided to the customer directly. For example, a self-checkout kiosk may display a message asking the customer if he has forgotten the item associated with the intangible transaction. Such a reminder may allow the customer to retrieve the item prior to leaving the store, thus possibly preventing the need for the customer to make a return trip to the physical retail store.

In an alternative approach shown in block 242, the alert may be provided to an employee of the physical retail store. The employee may then interact with the customer to remind them that they have engaged in an intangible transaction and need to retrieve and pay for the item they have ordered. Such techniques would be useful in reducing the costs borne by the physical retail store for items ordered and processed, but never picked up. In some cases, the system may also be used to resolve customer disputes in cases where the customer denies having engaged in the intangible transaction.

In block 245, data associated with identifying the customer may be deleted when the customer leaves the physical retail store. As described above, the techniques described herein generally do not require personally identifying data to be utilized. And even if they did, the techniques described above do not require this identifying data (whether personally identifying or not) to be retained once the customer has left the physical retail store. Thus the customer can be assured that any data associated with their intangible transaction is deleted once the intangible transaction has completed.

FIG. 3 is an example of a device that may implement the intangible shopping transactions in a physical retail store techniques described herein. It should be understood that FIG. 3 represents one example implementation of a computing device that utilizes the techniques described herein. Although only a single processor is shown, it would be readily understood that a person of skill in the art would recognize that distributed implementations are also possible. For example, the various pieces of functionality described above (e.g. video analytics, audio analytics, etc.) could be implemented on multiple devices that are communicatively coupled. FIG. 3 is not intended to imply that all the functionality described above must be implemented on a single device.

Device 300 may include processor 310, memory 320, non-transitory processor readable medium 330, order processing systems interface 340, video systems interface 350, audio systems interface 360, intangible transactions database 370, and checkout systems interface 380.

Processor 310 may be coupled to memory 320. Memory 320 may store a set of instructions that when executed by processor 310 cause processor 310 to implement the techniques described herein. Processor 310 may cause memory 320 to load a set of processor executable instructions from non-transitory processor readable medium 330. Non-transitory processor readable medium 330 may contain a set of instructions thereon that when executed by processor 310 cause the processor to implement the various techniques described herein.

For example, medium 330 may include monitor customer instructions 331. The monitor customer instructions 331 may cause the processor to monitor a customer as they interact with the physical retail store. For example, the processor may utilize the video systems interface 350 to access video systems within the physical retail store to determine if the customer is currently in areas where intangible transactions are expected to occur. The monitor customer instructions 331 are described throughout this description generally, including places such as the description of block 210.

The medium 330 may include identify customer instructions 332. The identify customer instructions 332 may cause the processor to identify the customer. As described above, identifying the customer does not necessarily require personally identifying the customer, but rather simply may require that a customer that engaged in an intangible transaction can be correlated with the same customer when he is attempting to leave the physical retail store. For example, the processor may utilize the video system interface 350 to perform facial recognition, body recognition, clothing recognition, etc. The techniques described herein may utilize any available video analytic technique to identify a customer and associate that customer with an identifier. In some cases, (e.g. online order/pick up in store, etc.) the processor may receive personally identifiable information (e.g. an image) for the customer. The identify customer instructions 332 are described throughout this description generally, including places such as the description of blocks 215-221.

The medium 330 may include determine intangible transaction has occurred instructions 333. The determine intangible transaction has occurred instructions 333 may cause the processor to determine that a customer has engaged in an intangible transaction. In some cases, the processor may utilize the order processing systems interface 340 to determine that a customer has engaged in an intangible transaction. As described above, transaction processing systems (e.g. order processing system 107, prescription system 117, online order system 127, etc.) may be utilized to track intangible transactions. Device 300 may be coupled to those systems in order to be made aware of the occurrence of intangible transactions.

In some cases, the processor may utilize the audio systems interface 360 to determine that a customer has engaged in an intangible transaction. As explained above, the processor may utilize the audio systems (e.g. audio systems 109, 119) to monitor the audio of interactions between the customer and store employees. The determine intangible transaction has occurred may include instructions to use known audio analytic techniques to analyze the audio received via the audio systems interface 360 to determine that an intangible transaction has occurred. The determine intangible transaction has occurred instructions 333 are described throughout this description generally, including places such as the description of blocks 225-229.

The medium 330 may include store transaction record instructions 334. The store transaction record instructions 334 may cause the processor to store a record in the intangible transactions database 370 whenever it detects that an intangible transaction has occurred. The record may include a customer identifier, as determined by identify customer instructions 332. The record may also include an indication of the item that is associated with the intangible transaction (e.g. the prescription, the cut of meat prepared as requested, etc.). The store transaction record instructions 334 are described throughout this description generally, including places such as the description of block 230.

The medium 330 may include determining customer attempting to leave instructions 335. The determining customer attempting to leave instructions 335 may cause the processor to detect that the customer is attempting to leave the store without the item associated with the intangible transaction. In some cases, the processor may utilize the checkout systems interface 380 to interact with the various checkout systems (e.g. checkout systems 190, 192, 194) to detect that the customer is attempting to leave the store without being in possession of the item associated with the intangible transaction. In some cases, the processor may interact with the video system interface to determine visually if the customer is leaving the store and is not in possession of the item associated with the intangible transaction. The determining customer attempting to leave instructions 335 are described throughout this description generally, including places such as the description of block 235.

The medium 330 may include provide alert instructions 336. The provide alert instructions 336 may cause the processor to generate an alert that the customer is attempting to leave the physical retail store while not in possession of the item that is associated with the intangible transaction. The provide alert instructions 336 are described throughout this description generally, including places such as the description of blocks 240-242.

The medium 330 may include delete data instructions 337. The delete data instructions 337 may cause the processor to delete all records of the intangible transaction once the customer has left the physical retail store. For example, all records in the intangible transactions database related to the customer (e.g. the identification information, the item associated with the intangible transaction, etc.) may be deleted once the customer has left the store, thus helping to preserve the customer's privacy. The delete data instructions 337 are described throughout this description generally, including places such as the description of block 245.

As should be apparent from this detailed description, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., and cannot [include a particular function/feature from current spec], among other features and functions set forth herein).

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through an intermediate elements or devices via an electrical element, electrical signal or a mechanical element depending on the particular context.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method comprising:
monitoring a customer shopping within a physical retail store to detect occurrence of an intangible transaction;
determining that the intangible transaction has occurred;
storing a record of a transaction item associated with the intangible transaction, the record associated with the customer;
determining the customer is attempting to leave the physical retail store while not in possession of the transaction item; and
providing an alert to indicate the customer is attempting to leave the physical retail store while not in possession of the transaction item.

2. The method of claim 1 wherein the monitoring of the customer occurs only in locations within the physical retail store where intangible transactions are likely to occur.

3. The method of claim 1 wherein the alert is provided to at least one of:
the customer; and
an employee of the physical retail store.

4. The method of claim 1 wherein the monitoring further comprises:
identifying the customer by at least one of:
facial recognition;
body recognition; and
clothing recognition.

5. The method of claim 4, wherein identifying the customer does not include personally identifying information, further comprising:
deleting data associated with identifying the customer when the customer leaves the physical retail store.

6. The method of claim 1 wherein detecting that an intangible transaction has occurred comprises at least one of:
monitoring audio communication between the customer and an employee of the physical retail store;
monitoring, via video, physical interaction between the customer and the employee of the physical retail store; and
monitoring records created by the employee of the physical retail store.

7. The method of claim 1 wherein the intangible transaction occurred prior to the customer entering the physical retail store, wherein monitoring the customer further comprises:
receiving an opt-in indication from the customer to be personally identified; and
detecting that the personally identified customer has entered the physical retail store.

8. A system comprising:
a processor; and
a memory coupled to the processor, the memory containing a set of instructions thereon that when executed by the processor cause the processor to:
monitor a customer shopping within a physical retail store to detect occurrence of an intangible transaction;
determine that the intangible transaction has occurred;
store a record of a transaction item associated with the intangible transaction, the record associated with the customer;
determine the customer is attempting to leave the physical retail store while not in possession of the transaction item; and
provide an alert to indicate the customer is attempting to leave the physical retail store while not in possession of the transaction item.

9. The system of claim 8 wherein the instructions to provide an alert further comprises instructions to provide the alert to at least one of:
the customer; and
an employee of the physical retail store.

10. The system of claim 8 wherein the instructions to monitor the customer further comprises instructions to identify the customer by at least one of:
facial recognition;
body recognition; and
clothing recognition.

11. The system of claim 10, wherein the instructions to identify the customer does not include personally identifying the customer, further comprising instructions to:
delete data associated with identifying the customer when the customer leaves the physical retail store.

12. The system of claim 8 wherein the instructions to detect that an intangible transaction has occurred comprises instructions to at least one of:
monitor audio communication between the customer and an employee of the physical retail store;
monitor, via video, physical interaction between the customer and the employee of the physical retail store; and
monitor records created by the employee of the physical retail store.

13. The system of claim 8 wherein the intangible transaction occurred prior to the customer entering the physical retail store, wherein the instructions to monitor the customer further comprises instructions to:
receive an opt-in indication from the customer to be personally identified; and
detect that the personally identified customer has entered the physical retail store.

14. A non-transitory processor readable medium containing a set of instructions thereon that when executed by a processor cause the processor to:
monitor a customer shopping within a physical retail store to detect occurrence of an intangible transaction;
determine that the intangible transaction has occurred;
store a record of a transaction item associated with the intangible transaction, the record associated with the customer;
determine the customer is attempting to leave the physical retail store while not in possession of the transaction item; and
provide an alert to indicate the customer is attempting to leave the physical retail store while not in possession of the transaction item.

15. The medium of claim 14 wherein the instructions to provide an alert further comprises instructions to provide the alert to at least one of:
the customer; and
an employee of the physical retail store.

16. The medium of claim 14 wherein the instructions to monitor the customer further comprises instructions to identify the customer by at least one of:
facial recognition;
body recognition; and
clothing recognition.

17. The medium of claim 16, wherein the instructions to identify the customer does not include personally identifying the customer, further comprising instructions to:
delete data associated with identifying the customer when the customer leaves the physical retail store.

18. The medium of claim 14 wherein the instructions to detect that an intangible transaction has occurred comprises instructions to at least one of:
monitor audio communication between the customer and an employee of the physical retail store;
monitor, via video, physical interaction between the customer and the employee of the physical retail store; and
monitor records created by the employee of the physical retail store.

19. The medium of claim 14 wherein the intangible transaction occurred prior to the customer entering the physical retail store, wherein the instructions to monitor the customer further comprises instructions to:
receive an opt-in indication from the customer to be personally identified; and
detect that the personally identified customer has entered the physical retail store.
